(19) United States
(12) Patent Application Publication
(10) Pub. No.: US 2012/0258372 A1
(43) Pub. Date: Oct. 11, 2012

(54) BATTERY LIFE EXTENDER

(76) Inventor: Takekuni Haneda, Honolulu, HI (US)

(21) Appl. No.: 13/083,409

(22) Filed: Apr. 8, 2011

(51) Int. Cl. H01M 10/08; C08L 29/04; C08L 77/04; C08K 5/098

(52) U.S. Cl. 429/326; 524/394

(57) ABSTRACT

A battery life extender for a lead-acid storage battery is provided and comprises a mixtures of polyvinyl alcohol, polylysine, and potassium or sodium sorbate (or sorbic acid), and optionally a preservative, such as sodium benzoate. The extender is added to a lead-acid storage battery. Distilled or deionized water can be included to adjust the specific gravity of the electrolyte. The extender substantially increases the operable life of lead-acid storage batteries.

### FIELD OF THE INVENTION

The invention relates to compositions for extending the life of lead-acid storage batteries, such as batteries used in forklifts and other vehicles with heavy use cycles.

### BACKGROUND OF THE INVENTION

Lead-acid storage batteries are used in all kinds of passenger vehicles, trucks, busses, electrical forklifts, all types of ships and airplanes, as backup power supplies for business computers and telephone exchanges, and as storage batteries for alternative energy systems such as solar and wind power. The cost of lead-acid batteries has steadily increased over the past eight years due to the ever increasing cost of lead, the major component of a lead-acid battery. Lead-acid batteries have a finite lifetime, and once it is reached, the batteries must be disposed of. It has been estimated that as many as 25% of all lead-acid batteries are disposed of illegally, posing a great threat to the environment.

In a lead-acid battery, the electrolytic solution contains dilute sulfuric acid (H₂SO₄) and has a specific gravity of about 1.28 to 1.30 (at 20° C.) when the battery is new. The active material of the positive electrode is lead dioxide (PbO₂) and the active material of the negative electrode is lead. The battery can be discharged and charged repeatedly according to equations (1) and (2):

Discharge: PbO₂+2H₂SO₄+Pb→2PbSO₄+2H₂O (1)

Charge: 2PbSO₄+2H₂O→PbO₂+2H₂SO₄+Pb (2)

Thus, discharging the battery causes the concentration of sulfuric acid in the electrolytic solution to decrease and lead (II) sulfate (PbSO₄) to be produced. Charging the battery causes a reaction opposite to that of discharging, decomposing the lead sulfate that was produced and increasing the concentration of sulfuric acid again.

A lead-acid battery can be charged and recharged only a finite number of times because use of the battery causes crystalline lead sulfate (PbSO₄) to be deposited and accumulate on the surface of the positive and negative electrodes of the battery. The crystalline lead sulfate is non-conducting and difficult to decompose, and it does not completely become lead dioxide and lead again, even during charging. This phenomenon is known as sulfation, and its gradual progression begins immediately after a rechargeable lead-acid battery is first used. Sulfation consumes the sulfuric acid in the electrolytic solution, which reduces the solution's specific gravity. It is possible to determine, approximately, the progression of sulfation and the life of the lead-acid battery by measuring the specific gravity of the electrolytic solution. Normally, the specific gravity is 1.28-1.3 at 20° C. in a new lead-acid rechargeable battery. As sulfation proceeds Table 1, the specific gravity drops and the battery's ability to be fully charged is diminished. Table 1 shows the relationship between specific gravity (measured with a hydrometer) and the extent of charging (measured with a volt meter).

TABLE 1
Effect of Specific Gravity on Cell Charging

| Specific Gravity | % Charge |
|---|---|
| 1.28 | 100 |
| 1.27 | 93.75 |
| 1.26 | 87.5 |
| 1.25 | 81.25 |
| 1.24 | 75 |
| 1.23 | 68.75 |
| 1.22 | 62.5 |
| 1.21 | 56.25 |
| 1.20 | 50 |
| 1.16 | 25 |
| 1.12 | 0 |

As sulfation progresses, so much crystalline lead sulfate accumulates that it becomes impossible to charge the battery further. In addition, battery performance (max. voltage) suffers. At a specific gravity of 1.28 (81.25% charge) or below, a lead-acid battery commonly used in electric forklifts will not function well. At a specific gravity of 1.22-1.23 or below, the forklift does not run or can no longer lift. Because of this, it is necessary to replace a lead-acid rechargeable battery with a new one every few years, for example, every two to three years for some automotive batteries, and every four to five years for forklift batteries. The discarded battery must be disposed of as industrial waste. Given the high demand for lead-acid batteries, and their finite life, a tremendous need exists for a battery life extender, both to avoid the expenditure of purchasing a new battery and to reduce the frequency with which lead-acid batteries are discarded as industrial waste.

One method of addressing this problem has been to add an organic polymer, such as sodium polyacrylate, to form colloidal particles with sulfate anions, which causes them to separate and degrades the crystalline lead sulfate carried by the colloidal particles on the electrode surface via electrical induction. Once such product, marketed as “InfiniFluid,” has been commercially available for a number of years and contains sodium polyacrylate, sorbic acid, sodium sulfate, salicylic acid, and sodium benzoate (as a preservative). Although, InfiniFluid can prolong the life of a typical lead-acid storage battery for a few years, further improvement is still desired.

### SUMMARY OF THE INVENTION

The present invention provides an improved composition for extending the operable life of a lead-acid storage battery, with particular utility as a battery life extender for commercial forklift batteries. In one embodiment, the composition comprises a mixture of polyvinyl alcohol, polylysine, and potassium or sodium sorbate. In another embodiment, the composition comprises a mixture of polyvinyl alcohol, polylysine, sorbic acid or a potassium or sodium salt thereof, a preservative (such as sodium benzoate), and water. Also provided is an improved lead-acid battery having lead or lead-antimony alloy plates, sulfuric acid, and a mixture of polyvinyl alcohol, polylysine, and potassium or sodium sorbate, or polyvinyl alcohol, polylysine, sorbic acid or a potassium or sodium salt thereof, a preservative, and water

### DETAILED DESCRIPTION

It has now been found that an improved composition for extending the life of a lead-acid storage battery can be realized by mixing polyvinyl alcohol, polylysine, and potassium or sodium sorbate. In one embodiment, the composition comprises polyvinyl alcohol, polylysine, sorbic acid or a potassium or sodium salt thereof, water, and a preservative, such as sodium benzoate. The components are provided as a mixture that can be added directly to the cell(s) of a lead-acid battery. In some embodiments, distilled or de-ionized water is used in the composition. The composition is referred to as a battery life extender or reconditioner, and is designed for use with both deep cycle and starting batteries, with lead as well as lead-antimony alloy plate electrodes. It can be packaged and sold in a suitable container, for example, a 1 gallon, high density polyethylene jug or bottle.

Polyvinyl alcohol (PVOH) is a water soluble polymer that behaves as an ionic liquid. Industrially, it is prepared by they hydrolysis of polyvinyl acetate, and the degree of hydrolysis is a variable feature of the polymer, which is available from numerous sources. In one embodiment of the invention, the polyvinyl alcohol has a degree of hydrolysis of at least 99 mol %, a viscosity of from 25 to 35 mPa·s (as measured in a 4% aqueous solution at 20° C.), and a pH of from 5 to 7. While not being bound by theory, it is believed that polyvinyl alcohol forms colloidal particles that passivate the battery electrodes, thereby retarding the accumulation of lead sulfate on the electrode surfaces.

A second component of the invention is polylysine, a preservative commonly used in food grade chemicals. It is stable against high temperatures. A third component of the composition is sorbic acid, or a salt thereof, i.e., sodium sorbate or potassium sorbate. Sorbic acid has antifungal properties and functions well in acidic environments. Without being bound by theory, it is believed that calcium sorbate and magnesium sorbate are either not readily available or are sub-optimal. Polylysine and sorbic acid and its salts are readily available from numerous sources.

In some embodiments, a small amount of an additional preservative, such as sodium benzoate, is included in the composition.

In some embodiments, the composition also contains a substantial amount of water, e.g., 75% or more, based on the total weight of the composition.

In a preferred embodiment, the relative amounts of polyvinyl alcohol, polylysine, and sorbic acid or salt thereof are, on a weight-by-weight basis, about 52:4:43. In other embodiments, the relative amounts of these three components are independently varied by as much as about ±7%, preferably no more than about ±5%, more preferably no more than about ±3%, or even more preferably, no more than about ±2%. Table 2 shows the relative amounts (by weight) of polyvinyl alcohol (PVOH), polylysine, and sorbic acid (or a salt thereof) within the stated ranges of variation.

TABLE 2
Relative amounts of Principal Components

| Component | Preferred | ±2% | ±3% | ±5% | ±7% |
|---|---|---|---|---|---|
| PVOH | 52 | 51-53 | 50-54 | 49-55 | 48-56 |
| Polylysine | 4 | 3.9-4.1 | 3.8-4.1 | 3.8-4.2 | 3.7-4.3 |
| Sorbic acid | 43 | 42-44 | 41-44 | 41-45 | 40-46 |

The composition is made by combining the ingredients as a mixture and then adding the liquid composition to the cell(s) of a new or used lead-acid storage battery. Purified water, e.g., distilled or deionized water, is added to the cell(s), either as part of the composition or separately, to adjust the specific gravity of the battery. In one embodiment, the amount (ml) of extender added is equivalent to about 10% of the storage capacity (expressed in amp-hours, Ah) of each cell. For example, for a 36V (18 cells) lead acid battery having a charge storage capacity of 800 Ah, 80 ml of extender is added to each cell (800×10%=80 ml), for a total of 1400 ml (800 ml/cell×18 cells=1400 ml.). As a second example, for a 48V (24 cells) battery having a storage capacity of 1000 Ah, 100 ml of extender are added to each cell (1000×10%=100 ml), for a total of 2400 ml (100 ml/cell×24 cells=2400 ml).

More generally, about 7% to 12% of extender is added to each cell, based on the storage capacity of the cell. Adding 15% would also work, but costs more. Adding as little as 5% may work, but it is unclear how effectively. 10% appears to be optimum.

Even a sealed battery can be reconditioned with the extender, provided that a hole is drilled in the battery to introduce the liquid and a suitable plug is inserted in the hole to seal the battery from leakage.

A typical lead-acid storage battery will stop functioning after it has been charged and discharged fully approximately 1,200 times. Tests conducted with the new composition reveal tremendous extension of battery life, as much as 3-4 times. In addition, the composition improves battery performance, with no degradation or loss of performance occurring during use. When the composition is added to a new battery, it possible to maintain the same degree of performance as that of a new battery, unless the battery becomes physically damaged. Without being bound by theory, it is believed that the polyvinyl alcohol continually cleans the surfaces of the electrodes and acts as a reaction promoter to decompose and remove crystalline lead sulfate that has adhered to the electrode surfaces. Additionally, polyvinyl alcohol is believed to have a protective effect on electrode surfaces from which lead sulfate has been removed, through its film-forming effects, and it is thought that the polyvinyl alcohol protects newly-exposed areas of electrode surfaces from the re-adhesion of lead sulfate, thereby greatly diminishing a reduction in battery performance.

### Example 1

A battery life extender was prepared according to one embodiment of the invention and added to a used lead-acid storage battery to evaluate its effect on battery performance. The extender contained the following components, on a percent-by-weight basis:

| | |
|---|---|
| polvinyl alcohol | 12% |
| polylysine | 1% |
| potassium sorbate | 10% |
| sodium benzoate | 1% |
| Purified water | 76% |

2.4 liters of extender was added to an Exide 48-volt lead-acid storage battery (24 cells; 680 amp/hour). The voltage and specific gravity of each cell were measured before the extender was added, and two weeks after the extender was added. The data are presented in Table 3.

TABLE 3
Performance of Example 1

| Battery without Extender | | | Battery with Extender | | |
|---|---|---|---|---|---|
| Cell | Specific Gravity | Voltage | Cell | Specific Gravity | Voltage |
| 1 | 1.27 | 2.077 | 1 | 1.28 | 2.087 |
| 2 | 1.26 | 2.071 | 2 | 1.28 | 2.082 |
| 3 | 1.27 | 2.079 | 3 | 1.29 | 2.091 |
| 4 | 1.28 | 2.096 | 4 | 1.30 | 2.106 |
| 5 | 1.27 | 2.083 | 5 | 1.29 | 2.094 |
| 6 | 1.27 | 2.090 | 6 | 1.29 | 2.104 |
| 7 | 1.27 | 2.077 | 7 | 1.28 | 2.088 |
| 8 | 1.27 | 2.078 | 8 | 1.28 | 2.089 |
| 9 | 1.25 | 2.053 | 9 | 1.28 | 2.091 |
| 10 | 1.26 | 2.077 | 10 | 1.28 | 2.088 |
| 11 | 1.26 | 2.075 | 11 | 1.28 | 2.087 |
| 12 | 1.27 | 2.077 | 12 | 1.29 | 2.097 |
| 13 | 1.27 | 2.083 | 13 | 1.29 | 2.095 |
| 14 | 1.26 | 2.083 | 14 | 1.28 | 2.094 |
| 15 | 1.26 | 2.075 | 15 | 1.28 | 2.085 |
| 16 | 1.24 | 2.055 | 16 | 1.28 | 2.090 |
| 17 | 1.27 | 2.083 | 17 | 1.28 | 2.094 |
| 18 | 1.28 | 2.096 | 18 | 1.29 | 2.108 |
| 19 | 1.27 | 2.092 | 19 | 1.29 | 2.105 |
| 20 | 1.26 | 2.073 | 20 | 1.28 | 2.085 |
| 21 | 1.27 | 2.084 | 21 | 1.28 | 2.096 |
| 22 | 1.27 | 2.089 | 22 | 1.29 | 2.102 |
| 23 | 1.28 | 2.096 | 23 | 1.29 | 2.106 |
| 24 | 1.27 | 2.091 | 24 | 1.29 | 2.103 |

| | | | |
|---|---|---|---|
| Total Voltage: | 49.933 | Total Voltage: | 50.225 |
| Average Voltage: | 2.081 | Average Voltage: | 2.094 |
| Average Cell | 1.267 | Average Cell | 1.284 |
| Specific Gravity: | | Specific Gravity | |

As shown in Table 2, the extender prepared according to Example 1 raised both the specific gravity and the voltage of all 24 cells in the battery.

The invention has been described with various features and embodiments but is not limited thereto. Additional modifications will be apparent to the skilled person. The invention is limited only by the appended claims and their equivalents.

What is claimed is:

1. A composition for extending the life of a battery, comprising:
a mixture of polyvinyl alcohol, polylysine, and potassium or sodium sorbate.

2. The composition recited in claim 2, wherein the polyvinyl alcohol, polylysine, and potassium or sodium sorbate are present in relative amounts of about 52:4:43 parts by weight, respectively.

3. The composition recited in claim 1, wherein the relative amounts of polyvinyl alcohol, polylysine, and potassium or sodium sorbate are independently varied by as much as ±2%.

4. The composition recited in claim 1, wherein the relative amounts of polyvinyl alcohol, polylysine, and potassium or sodium sorbate are independently varied by as much as ±3%.

5. The composition recited in claim 1, wherein the relative amounts of polyvinyl alcohol, polylysine, and potassium or sodium sorbate are independently varied by as much as ±5%.

6. The composition recited in claim 1, wherein the relative amounts of polyvinyl alcohol, polylysine, and potassium or sodium sorbate are independently varied by as much as ±7%.

7. The composition recited in claim 1, further comprising sodium benzoate.

8. The composition recited in claim 1, further comprising water.

9. The composition recited in claim 8, wherein the water is distilled water.

10. The composition recited in claim 8, wherein the water is de-ionized water.

11. A composition for extending the life of a battery, comprising:
a mixture of polyvinyl alcohol, polylysine, sodium or potassium sorbate, sodium benzoate, and water.

12. The composition recited in claim 11, wherein the polyvinyl alcohol, polylysine, and potassium or sodium sorbate are present in relative amounts of about 52:4:43 parts by weight, respectively.

13. The composition recited in claim 12, wherein the relative amounts of polyvinyl alcohol, polylysine, and potassium or sodium sorbate are independently varied by as much as ±2%.

14. The composition recited in claim 12, wherein the relative amounts of polyvinyl alcohol, polylysine, and potassium or sodium sorbate are independently varied by as much as ±3%.

15. The composition recited in claim 12, wherein the relative amounts of polyvinyl alcohol, polylysine, and potassium or sodium sorbate are independently varied by as much as ±5%.

16. The composition recited in claim 12, wherein the relative amounts of polyvinyl alcohol, polylysine, and potassium or sodium sorbate are independently varied by as much as ±7%.

17. A composition for extending the life of a battery, comprising:
polyvinyl alcohol, polylysine, sorbic acid or a potassium or sodium salt thereof, a preservative, and water.

18. The composition recited in claim 17, wherein the polyvinyl alcohol, polylysine, and sorbic acid or a potassium or sodium salt thereof are present in relative amounts of about 52:4:43 parts by weight, respectively.

19. The composition recited in claim 18, wherein the relative amounts of polyvinyl alcohol, polylysine, and sorbic acid or a potassium or sodium salt thereof are independently varied by as much as ±2%.

20. The composition recited in claim 18, wherein the relative amounts of polyvinyl alcohol, polylysine, and sorbic acid or a potassium or sodium salt thereof are independently varied by as much as ±3%.

21. The composition recited in claim 18, wherein the relative amounts of polyvinyl alcohol, polylysine, and sorbic acid or a potassium or sodium salt thereof are independently varied by as much as ±5%.

22. The composition recited in claim 18, wherein the relative amounts of polyvinyl alcohol, polylysine, and sorbic acid or a potassium or sodium salt thereof are independently varied by as much as ±7%.

23. The composition recited in claim 17, wherein the preservative comprises sodium benzoate.

24. A composition for extending the life of a battery, comprising, on a percent by weight basis:
a mixture of 12% polyvinyl alcohol, 1% polylysine, 10% potassium sorbate, 1% sodium benzoate, and 76% water

25. A method of extending the life a lead acid battery, comprising:
adding to the cell(s) of the battery a composition comprising a mixture of polyvinyl alcohol, polylysine, and sorbic acid or a sodium or potassium salt thereof.

26. The method recited in claim 25, wherein the relative amounts of polyvinyl alcohol, polylysine, and sorbic acid or a sodium or potassium salt thereof are independently varied by as much as ±2%.

27. The method recited in claim 25, wherein the relative amounts of polyvinyl alcohol, polylysine, and sorbic acid or a sodium or potassium salt thereof are independently varied by as much as ±3%.

28. The method recited in claim 25, wherein the relative amounts of polyvinyl alcohol, polylysine, and sorbic acid or a sodium or potassium salt thereof are independently varied by as much as ±5%.

29. The method recited in claim 25, wherein the relative amounts of polyvinyl alcohol, polylysine, and sorbic acid or a sodium or potassium salt thereof are independently varied by as much as ±7%.

30. The method recited in claim 25, further comprising sodium benzoate and water.

31. In a rechargeable battery having lead or lead-antimony alloy electrodes and a sulfuric acid electrolyte, the improvement comprising an additive in the electrolyte comprising a mixture of polyvinyl alcohol, polylysine, and sorbic acid or a sodium or potassium salt thereof.
